(19) United States
(12) Patent Application Publication
(10) Pub. No.: US 2006/0208187 A1
(43) Pub. Date: Sep. 21, 2006

(54) Apparatus and method for improved sensitivity and duty cycle

(76) Inventors: Alex Mordehai, Santa Clara, CA (US); Bryan D. Miller, Cupertino, CA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 11/084,830

(22) Filed: Mar. 18, 2005

(51) Int. Cl. H01J 49/42

(52) U.S. Cl. 250/292; 250/281; 250/282

(57) ABSTRACT

The present invention relates to an apparatus and method for providing improved sensitivity and duty cycle in a mass spectrometry system. The mass spectrometry system of the present invention includes an ionization source, a mass analyzer/filter and an ion detector. The mass analyzer has a first trapping section, a second trapping section and a gating section interposed between the first trapping section and the second trapping section. The device may further include one or more lenses adjacent to the gating or trapping sections. The invention also provides an ion trap. The ion trap of the present invention has a first trapping section, a second trapping section and a gating section interposed between the first trapping section and the second trapping section. The gating and trapping sections may be in a linear arrangement. A method regarding the application of the present invention is also described. For instance, the method of the present invention includes ionizing a sample, trapping ions in a trapping section, selecting ions using a gating section and trapping ions in a second trapping section.

### BACKGROUND

A mass spectrometry system is an analytical device that determines the molecular weight of chemical compounds by separating molecular ions according to their mass-to-charge ratio (m/z). Ions are generated by inducing either a loss or gain of charge and are then detected. Mass spectrometry systems generally comprise an ionization source for producing ions (i.e. electrospray ionization (EI), atmospheric photoionization (APPI), atmospheric chemical ionization (APCI), chemical ionization (CI), fast atom bombardment, matrix assisted laser desorption ionization (MALDI) etc.), a mass filter or analyzer (i.e. quadrupole, magnetic sector, time-of-flight, ion trap etc.) for separating and analyzing ions, and an ion detector such as an electron multiplier or scintillation counter for detecting and characterizing ions.

The first mass analyzers introduced in the early 1900's used magnetic fields for separating ions according to their mass-to-charge ratio. Just as ionization sources have evolved to handle various chemical molecules so have the mass analyzers associated with them. One type of mass analyzer is the ion trap. Ion trap mass analyzers operate by using two or more RF electrodes and end-caps to trap ions of a particular mass-to-charge ratio. The ion trap mass analyzer was developed around the same time as the quadrupole mass analyzer and the physics behind both of these analyzers are very similar. These mass analyzers are relatively inexpensive, provide good accuracy and resolution, and may be used in tandem for improved separations. Typical mass range and resolution for ion trap mass analyzers are (range m/z 200; resolution 2000). Other advantages of ion traps include small size, simple design, low cost, and ease of use for positive and negative ions. Ion trap mass analyzers have, therefore, become quite popular. However, ion traps suffer from a few particular problems. For instance, many of the designs suffer from the limitation that the ion trapping region is not uniform, the sensitivity could be improved, or the duty cycle is slow. In addition, many of the devices do not have the ability to continually scan and process ions as well as the capability to discriminate between ions at different stages of capture, accumulation, scanning or release.

Shortening duty cycle and improving overall ion production and processing is also important in mass spectrometry. Improved duty cycle may theoretically provide for improved sensitivity, lower processing time, better detection and shorter throughput allowing for the processing of more samples. A number of attempts have been made to improve duty cycles by use of external ion guides. However, most of these attempts have proven unsuccessful because the added couplings and lenses have actually increased complexity. The additional complexities inevitably lead to ion loss with little improvement in instrument sensitivity or duty cycle.

It, therefore, would be desirable to alleviate these problems by providing a device or mass analyzer that solves all these problems. In addition it would be desirable to provide a mass spectrometry system with improved overall sensitivity as well as improved duty cycle. These and other problems presented have been obviated by the present invention.

### SUMMARY OF THE INVENTION

The present invention relates to an apparatus and method for providing improved sensitivity and duty cycle in a mass spectrometry system. The mass spectrometry system of the present invention comprises an ionization source, a mass analyzer/filter and an ion detector. The mass analyzer of the present invention comprises a first ion trapping section, a second ion trapping section and a gating section interposed between the first ion trapping section and the second ion trapping section. The system may further comprise one or more optional gating lenses located between the ion source and the mass analyzer.

The invention also provides a mass analyzer. The mass analyzer of the present invention comprises a first ion trapping section, a second ion trapping section and a gating section interposed between the first ion trapping section and the second ion trapping section.

The method of the present invention comprises ionizing a sample, trapping ions in a first ion trapping section, selecting ions using a gating section and trapping ions in a second ion trapping section.

### BRIEF DESCRIPTION OF THE FIGURES

The invention is described in detail below with reference to the following figures:

FIG. 1 shows a general block diagram of a mass spectrometry system.

FIG. 2 shows a first embodiment of the present invention.

FIG. 3 shows a second embodiment of the present invention.

FIG. 4 shows a trapping section of the present invention.

FIG. 5 shows a gating section of the present invention.

FIG. 6 shows a second embodiment of a trapping section of the present invention.

FIG. 7 shows a third embodiment of the present invention.

FIG. 8 shows a fourth embodiment of the present invention.

FIG. 9 shows another embodiment of a trapping section of the present invention.

FIG. 10 shows a trace diagram of the present invention.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “a trapping section” includes more than one “trapping section”. Reference to a “gating section” includes more than one “gating section”. In describing and claiming the present invention, the following terminology will be used in accordance with the definitions set out below.

The term “adjacent” means contacting, spaced from, containing a portion, near, next to or adjoining. Something adjacent may be in contact with another component, may be spaced from the other component, may contain a portion of the other component, may be near another component, may be next to or adjoining the other component. For instance, a trapping section that is adjacent to a gating section may contact a gating section, be spaced from the gating section, may contain a portion of the gating section, may be near a gating section, may be next to or adjoining a gating section.

The term “section” refers to any apparatus, device or combination of devices that may comprise one or more electrodes for creating an electric or magnetic field.

The term “ion source” or “source” refers to any source that produces analyte ions.

The term “detector” refers to any device, apparatus, machine, component, or system that can detect an ion. Detectors may or may not include hardware and software. In a mass spectrometer the common detector includes and/or is coupled to a mass analyzer.

The term “duty cycle” refers to the time and efficiency for accumulation, scanning, fragmenting and detecting ions. Improved duty cycles result in increase efficiency and improved sensitivity.

The term “electrode” refers to any number of solid structures that may be electrically conductive and may be used to create an electric or magnetic field for manipulating ions. Electrodes may comprise a variety of materials and may be designed in a variety shapes, lengths and sizes.

The invention is described with reference to the figures. The figures are not to scale, and in particular, certain dimensions may be exaggerated for clarity of presentation.

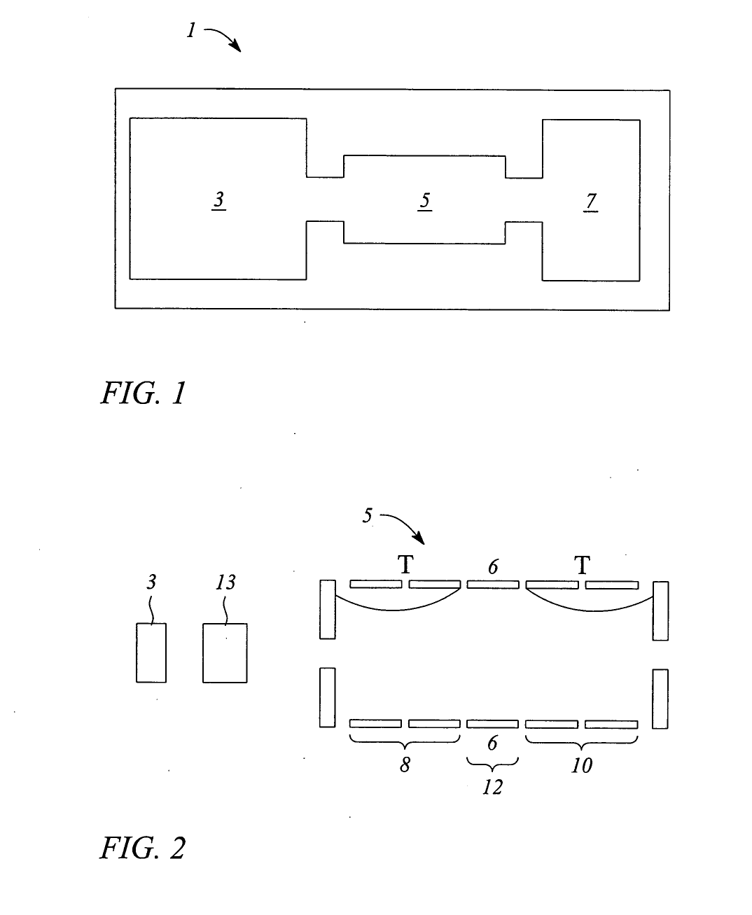

FIG. 1 shows a general block diagram of a mass spectrometer system. The block diagram is not to scale and is drawn in a general format because the present invention may be used with a variety of different types of mass spectrometery systems. A mass spectrometry system 1 of the present invention comprises an ion source 3, a mass analyzer 5 and a detector 7.

The ion source 3 may be located in a number of positions or locations. In addition, a variety of ion sources may be used with the present invention. For instance, electrospray ionization (ESI), chemical ionization (CI), atmospheric pressure ionization (APPI), atmospheric pressure chemical ionization (APCI), matrix assisted laser desorption ionization (MALDI), atmospheric pressure matrix assisted laser desorption ionization (AP-MALDI), electron impact ionization (EI) or other ion sources well known in the art may be used with the present invention. In particular, any source that may produce ions may be employed with the present invention. These sources may be known in the art or may be developed.

The mass analyzer 5 may comprise a variety of structures and designs. Additional details regarding the structure and designs are provided below.

The detector 7 is generally positioned downstream from the ion source 3 and the mass analyzer 5. The location of the detector 7 can vary with respect to the mass analyzer 5 and may not be on axis, but rather located on the side of the mass analyzer 5. The detector 7 may comprise any number of detectors known in the art. For instance, the detector 7 may comprise any device capable of generating an output signal indicative of the analyte being studied. Detectors may include and not be limited to devices that generate secondary electrons which are amplified or which induce a current generated by a moving charge. Some of these types of detectors include but are not limited to the electron multiplier and the scintillation counter.

FIG. 2 shows a first embodiment of the present invention. The figure is not to scale and is used for explanation and illustration purposes only. The mass analyzer 5 of the present invention may comprise an ion trap having a first trapping section 8, a second trapping section 10, and a gating section 12 interposed between the first trapping section 8 and the second trapping section 12. According to the present invention each of the sections of the mass analyzer 5 may have a substantially similar electrode profile to ensure close coupling between sections. Close coupling between sections here means that each section of the mass analyzer 5 is located adjacent to the next section without any obstruction to the ion path from one section to another. In general, several electrode profiles are possible, including, but not limited to round rod electrodes, substantially hyperbolic, stretched hyperbolic or rectangular electrodes. The mass analyzer 5 of the present invention utilizes an electrical field in radial plane within the gating section to gate ions between trapping sections. The trapping and gating sections are closely coupled together allowing for ion travel without mechanical obstructions between sections.

More than one trapping and gating section may be employed with the present invention. Trapping and gating sections may be placed in tandem or in any other arrangement that allows them to work cooperatively or effectively. In addition, a variety of trapping sections may be positioned before a gating section or vice versa. The various trapping and gating sections may be placed in any other logical configuration that allows for trapping, sorting and scanning ions. In certain embodiments optional gating lens 13 or other similar type devices may be employed between ion source 3 and the mass analyzer 5. Other optional lens may be employed for directing ions into the trapping sections. More than one lens may be applied and used with the present invention in a variety of places and orientations.

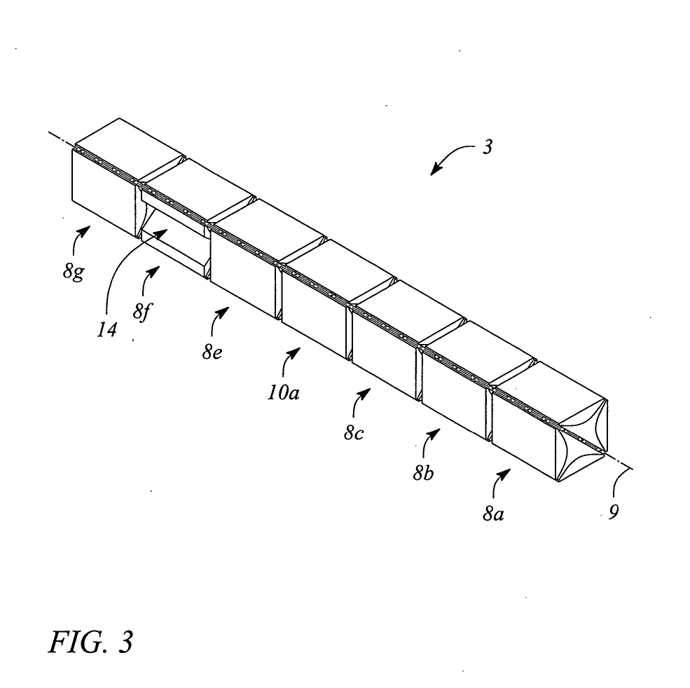

FIG. 3 shows a perspective view of a mass analyzer 3 of the present invention. In this embodiment, the mass analyzer 3 comprises on or more sections. For instance, the mass analyzer may comprise sections 8a, 8b, 8c, 10a, 8e, 8f, and 8g. In this embodiment of the invention, ions enter the device axially (i.e. along the central axis 9 of the structure) from the exterior adjacent to section 8a. The various sections may be operated together or at varying times and various different ways for accumulating, scanning and detecting analyte ions. These various processes define the duty cycle of the device. Placing these sections in tandem or in a contiguous relationship allows for an effective and efficient way to accumulate, scan and detect ions. It should also be noted that although each of the figures show sections 8a, 8b, 8c, 10a, 8e, 8f and 8g as being similar in shape and design, this is not a requirement of the invention. Other varying structures and combinations may be employed. In addition, section 10a has been labeled differently form 8a, 8b, 8c, 8e, 8f and 8g. However, in certain embodiments this structure may be the same or similar to these sections. Other locations, positions and orientations may be employed with the present invention.

As discussed, various sections can be employed with the present invention. The mass analyzer 3 can be separated into various trapping, mass analysis and gating sections. Sections 8a, 8b, and 8c in certain embodiments may actually be the trapping sections (although ions are typically and technically actually trapped, focused and stored only in the approximate central region of section 8b). Section 8d may in certain embodiments act as the gating section. Sections 8e, 8f and 8g in certain embodiments may actually comprise the mass analysis section.

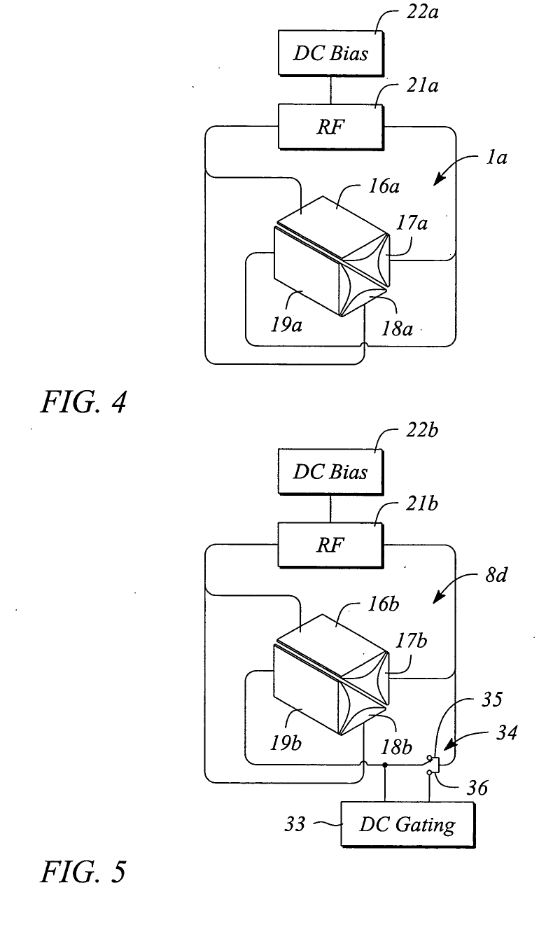

FIG. 4 shows a possible electrical connection arrangement for a trapping section of the present invention. For instance, this arrangement may be employed with the trapping sections 8a, 8b, and 8c. As shown in the diagram the electrical connection is between opposing electrodes. For instance, the first electrode 16a and the third electrode 18a are in electrical connection to each other and to RF voltage source 21a. A DC bias 22a is in electrical connection with the RF voltage source 21a. The second electrode 17a and the fourth electrode 19a are also in electrical connection with the RF voltage source 21a. It should be noted that other electrical connections and combinations know in the art may also be employed with the present invention. For instance, other connections and electrical connection between DC bias 22a, RF 21a and one or more of the electrodes 16a-19a.

FIG. 5 shows an embodiment of a gating section connection that may be employed with the present invention. In this embodiment, a gating voltage source 33 is employed to produce dipolar electrical field in a radial plane. The gating voltage source 33 may be DC, AC or other combinations. The figure shows the connection of the gating voltage source 33 to an RF voltage source 21b. RF voltage source 21b is also in electrical connection with DC bias 22b. The gating voltage source 33 can be connected in a dipolar fashion between two opposing electrodes such as first electrode 16b and third electrode 18b or second electrode 17b and fourth electrode 19b. An optional switch 34 may be employed with the present invention. The optional switch 34 may be engaged in one of two possible positions as shown in the diagram as reference numeral 35 and 36. In the present diagram position 35 may be considered the “off” position and position 36 the “on” position. This is only one particular embodiment of the invention. In certain instances the switch positions may be reversed or changed. Other type switches and designs known in the art may be employed. In the portrayed embodiment when the optional switch 34 is in position 35 ions are allowed to be transmitted and transported through section 8d. In contrast, when the optional switch 34 is in position 36 a dipolar electrical field is created within the section 8d that is used to retard the movement of ions through other downstream sections. It should be noted that gating sections similar to 8d may be employed for gating both positive and negative ions. It should also be recognized that the trapping sections 8a, 8b and/or 8c may also in certain instances be employed to operate like gating sections 8d, 8f and 8g. In this type of embodiment the gating would be different as discussed above and would separate ions according to polarity by providing a retarding axial field (as opposed to acting as a reflecting).

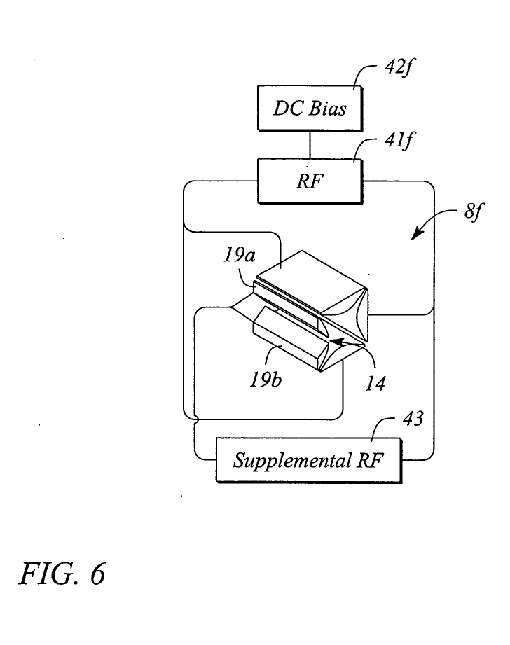

FIG. 6 shows electrical connections for another trapping embodiment of the present invention. In this embodiment of the invention a supplemental power supply 43 is employed with the present invention. The supplemental power supply 43 is in electrical connection with the RF voltage source 41f, optional DC bias 42f and electrodes 19a and 19b. The supplemental power supply 43 produces a resonant field inside of the section 8f and can be used for ion ejection, fragmentation or ion detection by way of ion ejection between electrodes 19a and 19b towards an ion detector 7 (not shown in this figure). In certain embodiments, a single electrode can be used instead of electrodes 19a and 19b. In this case, the primary use of this mass analysis section would be to isolate and/or fragment ions. In certain instances, when an aperture 14 is provided in the trapping or gating sections it may be employed to scan ions and determine the relative ions present.

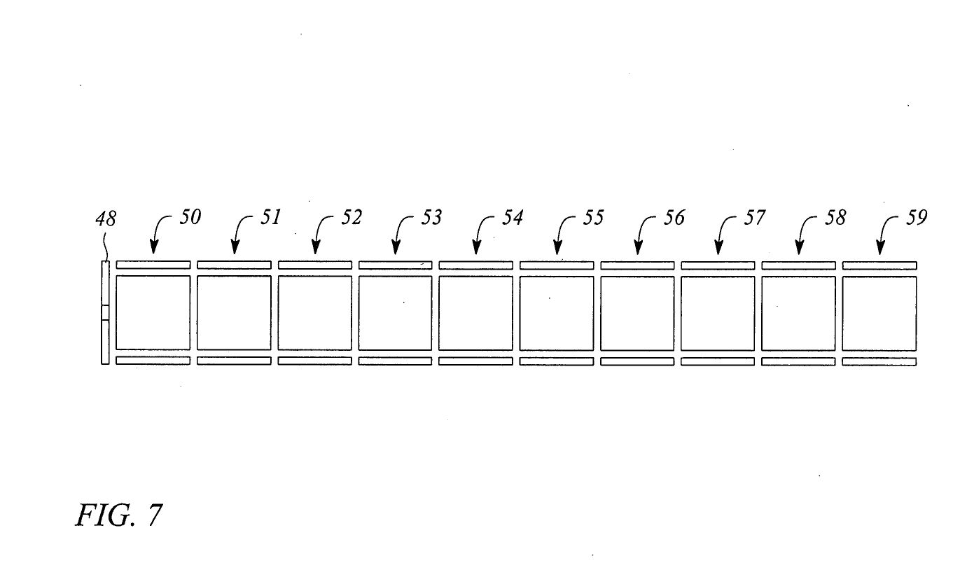

FIG. 7 shows another embodiment of the present invention. In this embodiment of the invention the mass analyzer 3 has a larger number of sections (numerical references 50 to 59) compared to the embodiments described above. This embodiment of the invention comprises two mass analyzer sections 54 and 58 and two gating sections 52 and 56 (not marked differently in the diagram). The other sections shown in the figure may be trapping sections. In this embodiment of the invention, ions can be stored first inside section 50 and confined by the DC potential from the entrance end near the lens 48 and trapping section 51, and transported in a similar manner as described above (i.e. they are first transported into section 54 and then into section 58). In this embodiment of the invention sections 54 and 58 can have RF fields of different frequencies and can be used to perform mass analysis in different m/z ranges. Also, the same sections can be used to pre-isolate, isolate and fragment ions of interest. In any case, since the mass analyzer continues to be available for the incoming ion beam it is possible to realize close to 100% duty cycle operation.

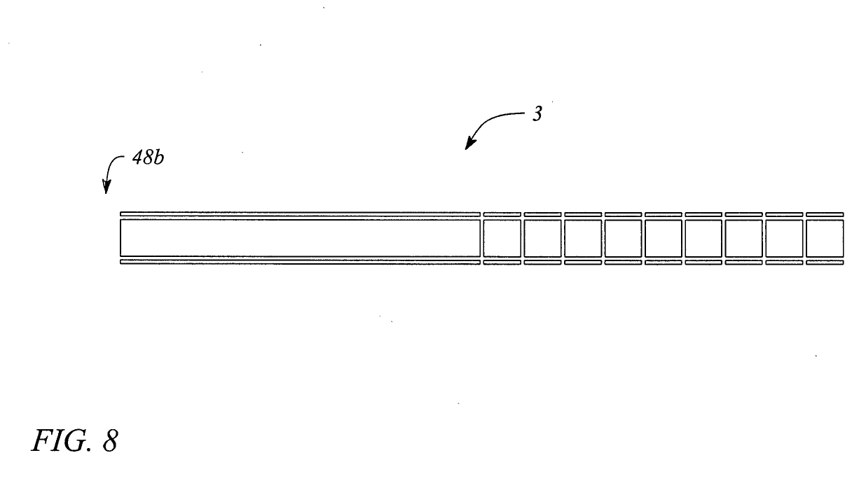

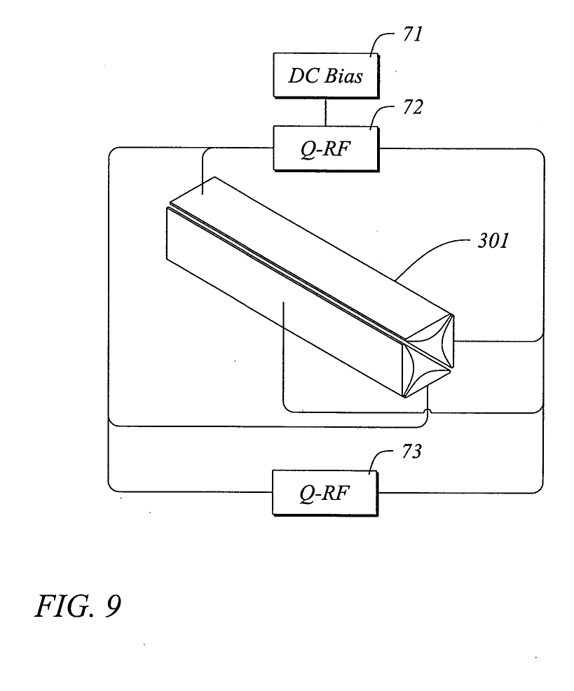

FIG. 8 shows another embodiment of the present invention. In this embodiment, the mass analyzer 3 shows a variety of sections placed in tandem. The entrance end 48b is substantially elongated and connect to the three power supplies 71, 72, and 73 for operation as a quadrupole mass filter (Not shown in FIG. 8. See FIG. 9.). Although a quadrupole is shown and illustrated other structures and number of electrodes may be employed. The electrical connection for the elongated trapping section is shown in FIG. 9. The quadrupole DC power supply 73 provides the appropriate quadrupole DC voltage, which can be used to operate the section as a mass filter to pre-select ions according to m/z ratio as they enter the mass analyzer 3. This design and features can be particularly beneficial for applications in which high levels of chemical background/noise ions are coincident with analyte ions.

Having discussed the apparatus of the invention in some detail a description of the method and operation of the invention is now in order.

The ratio of the times from ion accumulation, to the total time spent for ion accumulation, scanning and detection is called the duty cycle of the mass analyzer or mass spectrometer. Conventionally, it is desirable to lower the time it takes to process and detect ions. In addition, it is also important to accomplish this efficiently since that affects the overall sensitivity of the instrument.

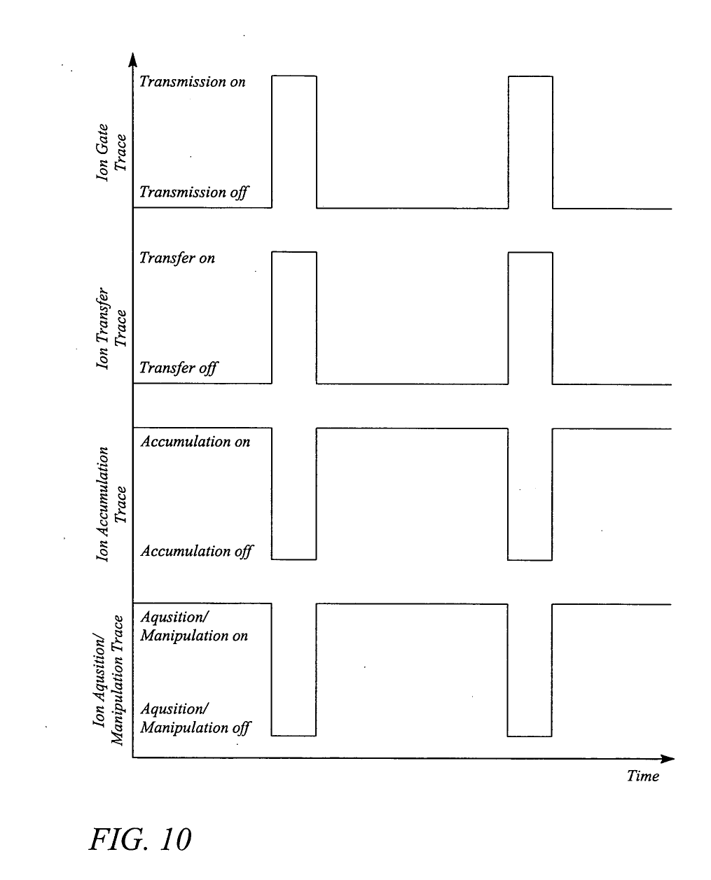

A description of the method of operation for the first embodiment will now be provided. The other embodiments operate generally the same or in a similar manner and for these reasons separate detailed descriptions have not been provided. It should be noted that the trace for each embodiment of the invention are essentially the same and can be seen in FIG. 10.

The operation and method of the present invention generally begins by the production of ions from the ion source 3. Ions are then transferred using one or more techniques, ion guides or collision cells to the mass analyzer 5. The mass analyzer 5 then accumulates, scans and separates the ions for the detector 7. Initially ions are transported or moved to trapping section 8a where they begin to travel along central axis 9 (See FIG. 3).

The duty cycle is defined as the time and efficiency for ions to be accumulated, scanned and ejected from section 8g into the detector 7. In many cases, ions are lost along the way or through the trapping or gating sections. The more ions lost, the lower the overall efficiency and duty cycle of the instrument.

Referring now to FIG. 3, during the first part of the duty cycle ions are accumulated in the center of the section 8b, while the gating section 10a prevents ion leakage from the initial ion beam along the device structure towards section 8e, 8f, 8d, 8g. In the simplest mode of operation, i.e. in a single MS mode, the accumulated ions in section 8b can be quickly transferred or transported down the combined structures to reach section 8f. During this transfer the appropriate DC voltage may be applied to sections 8b, 8c, 8d, 8e, and 8f to provide an appropriate electric field gradient to force the ions to move in a defined direction. Also, the gating section 10a is switched into “transmission off” mode and ions within section 10a can be scanned out to the detector 7 (shown in FIG. 1). For example scans may be taken by using resonance ion ejection through predefined aperture 14 in one or more of the trapping or gating sections (section 8f shows a similar type aperture). At the same time the DC potentials of the front sections 8c, 8b and 8a can be restored back to the trapping potential to continue accumulation of ions from the incoming ion beam. In this mode of operation the duty cycle approaches 100% since ions are sampled from the incoming beam during both the accumulation and the ion transfer time periods. The typical steps of ion trap operation are depicted in the form of a time diagram as shown in FIG. 9 (this is described in more detail below).

The operation of the invention can be extended beyond single MS mode. As shown in FIG. 5 ions can also be manipulated though application of appropriate potentials as known and described in the art. This can be done for isolation and fragmentation of ions. This can be performed in section 8f prior to scanning, and during this time interval sections 8a, 8b and 8c can accumulate ions. It is also recognized for extremely intense incoming ion beams an external gate 13 can be used to prevent rapidly overfilling the ion storage capacity of the device. In this case it is possible to control the gating section of the mass analyzer 10a by an external gate 13. This may occur during the short time interval when gating section 10a has been shut off by an instrument control unit. Instrument control units that provide negative feedback from the ion acquisition signal are known and described in the art.

The present invention method is particularly effective because of the placement and design of the trapping and gating sections. Alternating the gating and trapping sections with a linear ion trap works particularly effective.

The present invention improves overall duty cycle and sensitivity by being able to more efficiently accumulate, scan, trap and eject ions within a single mass analyzer. Since these functions can be done in tandem within closely coupled sections of a single mass analyzer there is less of an opportunity to lose ions during these processes. By employing both a gating and trapping section in the described arrangements or in alternating arrangements of trapping section(s) followed by gating section (s), the duty cycle of the instrument may be improved. This improves the overall instrument efficiency and sensitivity since less ions are lost during these processing stages.

FIG. 10 shows the overall trace for the present invention. The gate ion trace and the ion transfer trace are similar. In addition, the ion accumulation and acquisition traces are similar.

It is to be understood that while the invention has been described in conjunction with the specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications infra and supra mentioned herein are hereby incorporated by reference in their entireties.

We claim:

1. A mass spectrometry system, comprising:
(a) an ionization source for producing ions,
(b) a mass analyzer downstream from the ionization source, the mass analyzer comprising a first trapping section, a second trapping section and a gating section interposed between the first trapping section and the second trapping section; and
(c) a detector downstream from the mass analyzer for detecting ions from the mass analyzer.

2. A mass spectrometry system, as recited in claim 1, wherein the trapping section, the gating section and the trapping section of the mass analyzer are in linear alignment.

3. A mass spectrometer system as recited in claim 1, comprising a two dimensional mass analyzer.

4. A mass spectrometer system as recited in claim 1, wherein the first trapping section comprises four electrodes to define a quadrupole.

5. A mass spectrometer system as recited in claim 1, wherein the second trapping section comprises four electrodes to define a quadrupole.

6. A mass spectrometer system as recited in claim 2, wherein the gating section comprises four electrodes to define a quadrupole.

7. A mass analyzer, comprising:
a. a first section for trapping ions;
b. a second section for trapping ions; and
a gating section interposed between the first trapping section and the second trapping section for use in ion selection.

8. A mass analyzer as recited in claim 7, wherein the first trapping section comprises four electrodes to define a quadrupole.

9. A mass analyzer as recited in claim 7, wherein the second trapping section comprises four electrodes to define a quadrupole.

10. A mass analyzer as recited in claim 7, wherein the gating section comprises four electrodes to define a quadrupole.

11. A method of trapping, fragmenting and scanning ions in a mass spectrometry system, comprising:
a. ionizing a sample;
b. applying a first RF field from a first RF source to trap ions in a mass analyzer;
c. applying a second RF field from a second RF source to fragment ions in the mass analyzer; and
d. scanning the fragmented ions.

12. The method of claim 11, wherein the mass analyzer comprises a linear ion trap.

13. The method of claim 11, wherein the ionizing step is accomplished using an ion source selected from the group consisting of an APPI source, an EI source, an APCI source, a multimode source, and a CI source.
